(19) United States
(12) Patent Application Publication
(10) Pub. No.: US 2012/0240824 A1
(43) Pub. Date: Sep. 27, 2012

(54) METHOD FOR EXTRACTING BITUMEN FROM AN OIL SAND FEED STREAM

(75) Inventor: Michael David LANKSHEAR, Amsterdam (NL)

(73) Assignee: SHELL OIL COMPANY, Houston, TX (US)

(21) Appl. No.: 13/424,562

(22) Filed: Mar. 20, 2012

(30) Foreign Application Priority Data
Mar. 21, 2011 (CA) 2734465
Aug. 31, 2011 (CA) 2751251

(51) Int. Cl. C10G 1/04; C04B 24/36; C10C 3/00

(52) U.S. Cl. 106/668; 208/390; 208/23

(57) ABSTRACT

A method for extracting bitumen from an oil sand feed stream comprises at least the steps of: (a) providing an oil sand feed stream; (b) contacting the oil sand feed stream with an aliphatic hydrocarbon solvent thereby obtaining a solvent-diluted oil sand slurry; (c) separating the solvent-diluted oil sand slurry, thereby obtaining a solids-depleted stream and a solids-enriched stream; and (d) removing solvent from the solids-enriched stream thereby obtaining a dry product comprising sand and bitumen, wherein the bitumen in the dry product comprises at least 40 wt. % asphaltenes.

### CROSS REFERENCE TO EARLIER APPLICATIONS

The present application claims priority to Canadian application No. 2751251, filed on 31 Aug. 2011, which is incorporated herein by reference.

### FIELD OF THE INVENTION

The present invention relates to a method for extracting bitumen from an oil sand.

### BACKGROUND OF THE INVENTION

Various methods have been proposed in the past for the recovery of bitumen (sometimes referred to as “tar” or “bituminous material”) from oil sands as found in various locations throughout the world and in particular in Canada such as in the Athabasca district in Alberta and in the United States such as in the Utah oil sands. Typically, oil sand (also known as “bituminous sand” or “tar sand”) comprises a mixture of bitumen (in this context also known as “crude bitumen”, a semi-solid form of crude oil; also known as “extremely heavy crude oil”), sand, clay minerals and water. Usually, oil sand contains about 5 to 25 wt. % bitumen (as meant according to the present invention), about 1 to 13 wt. % water, the remainder being sand and clay particles.

As an example, it has been proposed and practiced at commercial scale to recover the bitumen content from the oil sand by mixing the oil sand with water and separating the sand from the aqueous phase of the slurry formed. Disadvantages of such aqueous extraction processes are the need for extremely large quantities of process water (typically drawn from natural sources) and issues with removing the bitumen from the aqueous phase (whilst emulsions are being formed) and removing water from the bitumen-depleted sand.

Other methods have proposed non-aqueous extraction processes to reduce the need for large quantities of process water. Example of such a non-aqueous extraction process are disclosed in e.g. U.S. Pat. No. 3,475,318 and US 2009/0301937, the teaching of which is hereby incorporated by reference.

U.S. Pat. No. 3,475,318 discloses a process of selectively removing bitumen from oil sands by solvent extraction with subsequent solvent recovery. The extraction solvent contains a saturated hydrocarbon having from 5 to 9 carbon atoms per molecule or mixtures thereof. For removal of asphaltenes (to be used as process fuel), an aromatic solvent such as benzene or toluene is used.

US 2009/0301937 discloses a method for preparing solvent-dry, stackable tailings. The method includes a primary extracting process using a first solvent (typically a light aromatic solvent) that separates most of the bitumen from a material comprising bitumen and produces a first solvent-wet tailings. The first solvent-wet tailings are washed with a second solvent (typically an aliphatic solvent) that removes the first solvent from the tailings. The second solvent remaining in the tailings is removed thereby producing solvent-dry, stackable tailings.

A problem of known methods of non-aqueous solvent extraction of bitumen from oil sand is that the sand product (or “tailings”) obtained in the extraction process are not immediately suitable for landfill, storage or alternative use, in view of the dustiness of the sand product caused by the large amount of fine material being present.

### SUMMARY OF THE INVENTION

It is an object of the present invention to solve or minimize this problem.

It is a further object of the present invention to provide an alternative non-aqueous solvent based extraction process for extracting bitumen from an oil sand.

One or more of the above or other objects are achieved according to the present invention by providing a method for extracting bitumen from an oil sand feed stream, the method comprising at least the steps of:

(a) providing an oil sand feed stream;
(b) contacting the oil sand feed stream with a liquid comprising an aliphatic hydrocarbon solvent thereby obtaining a solvent-diluted oil sand slurry;
(c) separating the solvent-diluted oil sand slurry, thereby obtaining a solids-depleted stream and a solids-enriched stream; and
(d) removing solvent from the solids-enriched stream thereby obtaining a dry product comprising sand and bitumen, wherein the bitumen in the dry product comprises at least 40 wt. % asphaltenes (pentane insoluble, in particular as determined according to ASTM D6560-IP 143/01). Preferably, the bitumen in the dry product comprises at most 95 wt. % asphaltenes, preferably at most 93 wt. %, more preferably at most 90 wt. %.

It has now surprisingly been found according to the present invention that the dry (“tailings”) product (comprising sand and bitumen) as obtained according to the present invention has a decreased dustiness without the need to add water. Hence the dry product as obtained according to the present invention is immediately suitable for landfill, storage or alternative use (such as in sulphur concrete). In the context of the present description, with the term “dry product” is meant that substantially all aliphatic hydrocarbon solvent as used for the bitumen extraction process has been removed. Also, the dry product has typically a low water content, such as below 10.0 wt. %, preferably below 7.5 wt. %.

According to the present invention, the providing of the oil sand can be done in various ways. Typically, before contacting the dry oil sand (which may contain some water being present in the oil sand) with the solvent the oil sand particles are reduced in size, e.g. by crushing, breaking and/or grinding, to below a desired size upper limit. Experience in large scale operations shows that the achievable size upper limit for such size reduction is currently about 8 inch.

The contacting of the oil sand with the liquid comprising solvent thereby obtaining a solvent-diluted oil sand slurry is not limited in any way. As an example, the liquid may be added before, during or after the size-reducing step (if available) of the oil sand. Further size reduction in the presence of the liquid (comprising the solvent) may be performed; part of the size reduction may take place by dissolution of bitumen present in the oil sand, but further size reduction e.g. by using screens or again crushers, breakers or grinders may be performed, if desired. Typically, the solvent forms the major part of the liquid and is preferably present in an amount of from 55 wt. % up to 100 wt. %, preferably above 58 wt. %, more preferably above 62 wt. %, based on the amount of the liquid.

The solvent as used in the method of the present invention may be any saturated or unsaturated aliphatic (i.e. non-aromatic) solvent and may include linear, branched or cyclic alkanes and alkenes and mixtures thereof. Preferably, the solvent in step (b) comprises an aliphatic hydrocarbon having from 3 to 9 carbon atoms per molecule, more preferably from 4 to 7 carbons per molecule, or a combination thereof. Especially suitable solvents are saturated aliphatic hydrocarbons such as propane, butane, pentane, hexane, heptane, octane and nonane, in particular butane, pentane, hexane and heptanes (and isomers thereof). It is preferred that the solvent in step (b) comprises at least 90 wt. % of the aliphatic hydrocarbon having from 3 to 9 carbon atoms per molecule, preferably at least 95 wt. %. Also, it is preferred that in step (b) substantially no aromatic solvent (such as toluene or benzene) is present, i.e. less than 5 wt. %, preferably less than 1 wt. %. Herewith, the asphaltene content of the bitumen in the bitumen-depleted sand remains relatively high when compared with the asphaltene content of the bitumen in the original oil sand feed stream.

According to an especially preferred embodiment of the present invention, the particles of the solvent-diluted oil sand slurry obtained in step (b) are reduced in size to have a diameter below 5.0 cm, preferably below 4.0 cm, more preferably below 3.0 cm. As the size reduction is performed in the presence of solvent (rather than size reduction under dry conditions), this helps breaking down the larger particles and dissolving the bitumen thereby avoiding the formation of sticky lumps. Additionally, by mixing the oil sand feed stream with the solvent before performing the separating (in step (c)), the viscosity of the bitumen present in the oil sand is reduced.

Typically, the solvent-diluted oil sand slurry has a solvent-to-bitumen (S/B) weight ratio of from 0.5 to 5.0, more typically above 0.7. Preferably, the solvent-diluted oil sand slurry has a solvent-to-bitumen (S/B) weight ratio of above 1.0, preferably above 1.2, more preferably above 1.4, even more preferably above 1.6 and below 5.0, preferably below 3.0, more preferably below 2.5. Further it is preferred that the solvent-diluted oil sand slurry obtained in step (b) comprises from 20 to 50 vol. % of solids.

After contacting the oil sand with the solvent in step (b), the solvent-diluted oil sand slurry is separated in step (c), thereby obtaining a solids-depleted stream and a solids-enriched stream. This separation step can be performed in many different ways such as by means of filtration, settling, use of a cyclone, etc.

After the separation step of step (c), solvent is removed from the solids-enriched stream thereby obtaining a dry product comprising sand and bitumen. The person skilled in the art will readily understand that this removal of solvent can be performed in many ways. The solvent may be reused in the contacting step (b) and/or separation step (c).

It is preferred that the solvent is removed from the solids-enriched stream such that the dry product contains less than 500 ppmw of the solvent, preferably less than 300 ppmw. Also it is preferred that during the removal of the solvent, the water content of the dry product is not increased (such as by using e.g. steam to drive the removal of solvent); in general it is desired according to the present invention that the water content of the product comprising sand and bitumen as obtained in steps (c) and (d) is not increased during the bitumen extraction process.

In a further aspect the present invention provides a product obtainable by the method according to the present invention.

In a further aspect, the present invention provides a composition, at least comprising sand and bitumen, wherein the bitumen contains at least 40 wt. % asphaltenes, as determined according to ASTM D6560-IP 143/01. Preferably, the bitumen contains at least 50 wt. % asphaltenes, preferably at least 60 wt. %. Also it is preferred that the bitumen comprises at most 95 wt. % asphaltenes, preferably at most 93 wt. %, more preferably at most 90 wt. %.

Typically, the composition according to the present invention comprises from 80 to 98 wt. % sand, preferably from 85 to 97 wt. %. The person skilled in the art will readily understand what is meant with “sand”. Typically, the sand contains mineral solid sand and clay particles. Part of the sand may be in the form of fine particles (or “fines”); preferably the composition comprises less than 15 wt. % fine particles having a particle size of less than 44 μm, as would be obtained during e.g. screening of the dry sand composition using a screen having a mesh size of 44 μm. Please note that such fine particles may be present in the composition according to the present invention in an amount higher than 15 wt. %, but appear to be agglomerated by the presence of asphaltenes.

Typically, the composition comprises from 0.1 to 10.0 wt. % bitumen, preferably below 5.0 wt. %, more preferably below 4.0 wt. %, even more preferably below 3.0 wt. %. Also, the composition typically has a low water content, such as from 0.1 to 10.0 wt. %, preferably below 7.5 wt. %.

Further it is preferred that at least 90 wt. %, preferably at least 95 wt. %, of the composition has a maximum particle size of at most 5.0 cm, preferably at most 4.0 cm.

Also it is preferred that the composition comprises less than 500 ppmw, preferably less than 300 ppmw, of an aliphatic hydrocarbon solvent.

According to an especially preferred embodiment of the present invention, the composition has a dustiness of less than 10 g/kg sand as determined by DIN-5992-1, preferably less than 8, more preferably less than 6, even more preferably less than 4, yet more preferably less than 2 g/kg sand. Typically, the dustiness is above 0.1 g/kg sand.

In an even further aspect, the present invention provides the use of the product or the composition according to the present invention in sulphur concrete (including mortar objects), sulphur and bitumen based concrete or asphalt.

### BRIEF DESCRIPTION OF THE DRAWINGS

Hereinafter the invention will be further illustrated by the following non-limiting drawing. Herein shows:

FIG. 1 schematically a process scheme of a first embodiment of a method in accordance with the present invention;

FIG. 2 schematically a process scheme of a second embodiment of a method in accordance with the present invention; and

FIG. 3 schematically a process scheme of a third embodiment of a the method in accordance with the present invention.

For the purpose of this description, a single reference number will be assigned to a line as well as a stream carried in that line.

### DETAILED DESCRIPTION OF THE PREFERRED EMBODIMENTS

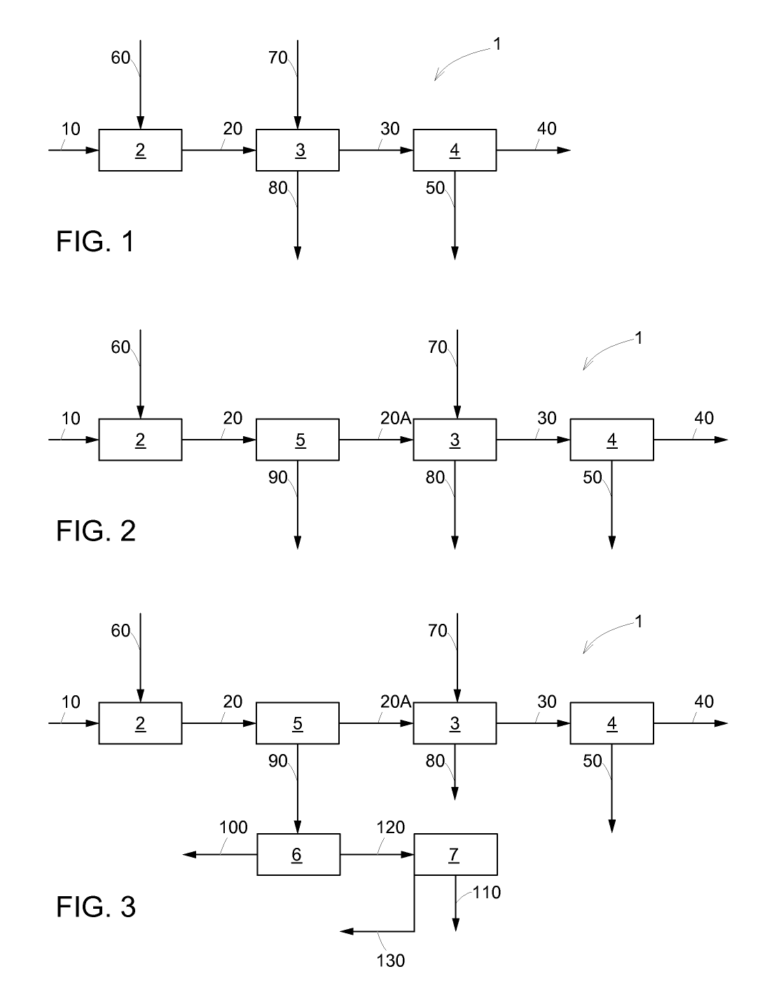

FIG. 1 schematically shows a simplified process scheme according to the present invention for extracting bitumen (i.e. in the context of the invention a bituminous and/or extremely heavy crude oil like material) from an oil sand feed stream. The process scheme is generally referred to with reference numeral 1. The process scheme 1 shows a mixer 2, a filter 3 and a dryer 4.

During use of the process scheme of FIG. 1, an oil sand feed stream 10 is provided and fed to the mixer 2. Typically, before entering the mixer 2, the dry oil sand feed stream 10 has been crushed or treated otherwise, to reduce the size of the larger oil sand lumps to below a pre-determined upper limit. Experience in large scale operations shows that the achievable size upper limit for such size reduction is currently about 8 inch. Further size reduction of the dry oil sand feed stream 10 by mechanical means usually results in blockage due to the sticky, viscous nature of the oil sand. Further size reduction may take place once solvent used for the bitumen extraction has been added.

In the mixer 2, the dry oil sand feed stream 10 is mixed with solvent stream 60 (containing an aliphatic hydrocarbon solvent and a certain amount of bitumen) recycled from downstream of the process thereby obtaining a solvent-diluted oil sand slurry 20. Usually, in the mixer 2 (or in a separate unit, if needed), the particles of the solvent-diluted oil sand slurry obtained are reduced in size, typically to have a diameter below 5.0 cm. Any undesired materials (such as rocks and woody material) that may hinder downstream processing may be removed by using screens or the like (preferably in the presence of solvent) and the remaining oil sand particles are reduced in size in the presence of the solvent, e.g. by crushing, breaking and/or grinding.

The slurry stream 20 exiting the mixer 2 is fed into the filter 3 for filtration. Typically, the solvent-diluted oil sand slurry 20 as fed to the filter 3 comprises from 20 to 60 vol. % of solids, preferably from 30 to 50 vol. %. In the embodiment of FIG. 1, in filter 3 a wash solvent 70 is used. The wash solvent 70 may have been recycled from a point downstream in the process; of course, instead or in addition fresh wash solvent (not shown) may be added as well.

In the filter 3, the solvent-diluted oil sand slurry 20 is filtered, thereby obtaining a solids-enriched stream 30 and a solids-depleted filtrate 80. The solids-depleted filtrate 80 is typically further processed and eventually sent to a refinery (not shown) for recovering the bitumen. Any solvent recovered from stream 80 may be reused in mixer 2 (as all or part of stream 60) or filter 3 (as all or part of stream 70). Also, a part of stream 80 may be directly recycled to the mixer 2.

The solids-enriched stream 30 is sent to the dryer 4 to remove most of the remaining solvent thereby obtaining a dry product stream 40 and a solvent stream 50 (which may still contain some bitumen). The solvent stream 50 is typically reused upstream in the process, e.g. as solvent in the mixer 2 or as wash solvent in filter 3. The dry product stream 40 (comprising sand and bitumen, wherein at least 40 wt. % of the bitumen in the dry product is asphaltenes) is usually used for land reclamation.

FIG. 2 schematically shows an alternative simplified process scheme according to the present invention. In the embodiment of FIG. 2 a settler 5 is present between the mixer 2 and the filter 3. The slurry stream 20 exiting the mixer 2 is separated in the settler 5 into a solid rich stream 20A that is fed into the filter 3 and a solids-depleted stream 90. All or parts of streams 50, 80 and 90 may be reused, e.g. as stream 60 or stream 70.

FIG. 3 schematically shows a further alternative simplified process scheme according to the present invention. In the embodiment of FIG. 3 the solids-depleted stream 90 is sent to a clarifier 6. From the clarifier 6 a solid-enriched stream 100 may be sent to the mixer 2 and/or the filter 3, and a solids-depleted stream 120 may be sent to an SRU (Solvent Recovery Unit) 7. Stream 50 leaving the dryer 4 may be reused, e.g. in the mixer 2 and/or filter 3 (as stream 60 and/or 70), after optional condensation. A recovered solvent stream 110 may be sent from the SRU 7 to the filter 3 (as all or part of stream 70); also, a bitumen-enriched product stream 130 will be removed from the SRU 7. The solids-depleted stream 80 leaving filter 3 may be reused at least partly in mixer 2 (as all or part of stream 60).

The person skilled in the art will readily understand that many modifications may be made without departing from the scope of the invention.

The present invention is described below with reference to the following Examples, which are not intended to limit the scope of the present invention in any way.

### EXAMPLES

### Example 1

A 401 g sample of an Athabasca oil sand (having a bitumen content of 12.3 wt. %) and 80 g solvent (n-pentane) were mixed for 30 minutes under ambient conditions using a tumbler bank (Reax 20, Heidolph (Schwabach, Germany); 15 rpm settings) to form a slurry. The slurry was allowed to settle, and the decantate on top of the sample was removed by suction in order to obtain a thick slurry for the subsequent separation step. The slurry was transferred to a filtration vessel and the surface of the sand leveled. 80 g of fresh solvent (n-pentane) was added (as wash solvent) on top of the filter cake and pushed through the filter cake under pressure (0.3 barg). Remaining solvent was removed from the sand by purging with nitrogen.

### Example 2

The procedure of Example 1 was repeated except that a 401 g sample of an Athabasca oil sand (having a bitumen content of 10.3 wt. %) and 95 g solvent (n-pentane) were used to form the slurry and 100 g fresh solvent (n-pentane) was used (as wash solvent) during the filtration and pushed through the filter cake under a pressure of 0.8 barg.

### Example 3

The procedure of Example 1 was repeated except that a 401 g sample of an Athabasca oil sand (having a bitumen content of 8.4 wt. %) and 100 g solvent (n-pentane) were used to form the slurry and 80 g fresh solvent (n-pentane) was used (as wash solvent) during the filtration.

### Example 4

The procedure of Example 1 was repeated except that a 400 g sample of an Athabasca oil sand (having a bitumen content of 9.9 wt. %) and 100 g solvent (n-pentane) were used to form the slurry and 100 g fresh solvent (n-pentane) was used (as wash solvent) during the filtration.

### Comparative Example 1

The procedure of Example 1 was repeated except that a 400 g sample of an Athabasca oil sand (having a bitumen content of 9.9 wt. %) and 100 g solvent (toluene) were used to form the slurry and 140 g fresh solvent (toluene) was used (as wash solvent) during the filtration.

In Table 1 below, the S/B weight ratio of the solvent-diluted oil sand slurry, the bitumen content (in wt. %) in the dry sand (i.e. after removal of solvent by purging with nitrogen), the asphaltene and maltene content (in wt. %) of the bitumen in the dry sand and the water content of the dry sand are given for Examples 1-4 and Comparative Example 1. The asphaltene content was determined according to ASTM D6560-IP 143/01 except that:

pentane was used instead of heptane;

0.5 g of bitumen was used with 5 ml pentane, being sealed in a screw-top test tube

instead of heating under reflux, the bitumen/pentane sample was sonicated at 35° C. for 15 minutes in an ultrasonic water bath. The sonicated suspension was still allowed to stand in the dark for 150 minutes as per ASTM D6560.

a Buchner glass filtration apparatus with Millipore filters was used in place of the folded filter paper apparatus. The dry filter papers were tared before use.

hot solvent (pentane) was not used in the filtration step.

Rather than re-extracting the collected asphaltenes with toluene, the filter paper was folded over the asphaltenes collected to contain them. The samples were then warmed in the oven for 20 minutes at 75° C., allowed to cool, then weighed to determine the asphaltene content. The difference between the filter+asphaltene and filter only weights gave the mass of asphaltenes.

### Example 5

Similar to Example 1, a 1216 g sample of Athabasca oil sand (having a bitumen content of 10.3 wt % and a fines content* (particle size<44 microns) of 26 vol. % as determined by Laser diffraction on a Malvern Mastersizer2000 (available from Malvern Instruments Ltd, Worcestershire, UK)) and 374 ml solvent (n-pentane) were mixed for 30 minutes under ambient conditions using a tumbler bank (Reax 20; 15 rpm settings) to form a slurry. The slurry was transferred to a filtration vessel and the surface of the sand leveled. 427 ml of fresh solvent (n-pentane was added (as wash solvent) on top of the filter cake and pushed through the filter cake under pressure (0.3 barg). The wash step was repeated once. Remaining solvent was removed from the sand by drying, first under ambient conditions and subsequently at 100° C. in an oven under a nitrogen purge at reduced pressure (400 mbar).

*The fines content of the oil sand as determined above was performed as follows: an oil sand sample was gently disaggregated with a rubber pestle after oil and water were removed via a combined soxhlet/Dean-Stark extraction. From this a sample was taken and 2 drops of 0.5% Triton X-100 (available from Sigma-Aldrich) in de-ionized water were added. The sample was then gently mixed with the flat end of a spatula. A couple of drops of de-ionized water was added to completely wet the sample. Subsequently 2 ml of 5% sodium hexametaphosphate (96%; available from Sigma-Aldrich) in de-ionized water was added and the sample was gently mixed. The sample was then quantitatively transferred to the reservoir of the Malvern Mastersizer 2000. The sample was run with an obscuration between 6 and 14%. Samples were measured in duplicate. Instrument settings were as follows:

| | |
|---|---|
| Analysis sensitivity: | Enhanced |
| Background integration time: | 30 sec |
| Background snaps: | 30000 |
| Delay between measurements: | 5 |
| Dispersant refractive index: | 1.33 |
| Instrument firmware version: | 2.01 |
| Irregular shape mode: | On |
| Measurement integration time: | 30 sec |
| Measurement snaps: | 30000 |
| Number of measurements: | 2 |
| Obscuration range (lower): | 6 |
| Obscuration range (upper): | 14 |
| Particle refractive index: | 1.52 |
| Particle refractive index (blue): | 2.2 |
| Post clean: | On |
| Pre clean: | Off |
| Pump speed: | 2000 |
| Software version: | 5.6 |
| Stirrer speed: | 800 |
| Ultrasonic duration: | 45 |
| Ultrasonic level: | 100 |
| Ultrasonic mode: | Pre-measurement |

### Comparative Example 2

Similar to Example 5, a 750 g sample of the same Athabasca oil sand as used in Example 5 and 232 ml solvent (toluene) were mixed for 30 minutes under ambient conditions using a tumbler bank (Reax 20; 15 rpm settings) to form a slurry. The slurry was transferred to a filtration vessel and the surface of the sand leveled. 257 ml of fresh solvent (toluene) was added (as wash solvent) on top of the filter cake and pushed through the filter cake under pressure (0.3 barg). The wash step was repeated once. Remaining solvent was removed from the sand by drying, first under ambient conditions and subsequently at 100° C. in an oven under a nitrogen purge at reduced pressure (400 mbar).

TABLE 1

| | S/B | Bitumen | | | |
|---|---|---|---|---|---|
| | weight | content | | | |
| | ratio | of dry | Asphaltene | Maltene | Water |
| | of | sand | content* | content* | Content |
| | slurry | [wt. %] | [wt. %] | [wt. %] | [wt. %] |
| Example 1 | 1.6 | 2.0 | 72.7 | 27.3 | 2.8 |
| Example 2 | 2.3 | 2.2 | 79.1 | 20.9 | 4.0 |
| Example 3 | 3.0 | 1.9 | 71.9 | 28.1 | 4.1 |
| Example 4 | 2.5 | 2.1 | 71.2 | 28.8 | 2.5 |
| Comp. Ex. 1 | 2.5 | 0.4 | 12.9 | 87.1 | 4.0 |

*pentane insoluble, as determined according to ASTM D 6560-IP 143/01 (adapted)

### Dustiness

In order to determine the proneness to dustiness the sands as obtained in Examples 1-4 and Comparative Example 1 were subjected to visual inspection. When the samples were contained in a glass jar and shaken, the Comparative Example 1 showed dry particles sticking to the wall. The samples of Examples 1-4 did not show such sticking of dry particles and can therefore be seen as having a reduced dustiness. Also, Comparative Example 1 appeared to be more sticky.

The dustiness of the compositions of Example 5 and Comparative Example 2 were determined (triplo measurement) according to DIN-5592-1 except for:

a runtime of 1 minute (instead of 5 minutes);

a flow rate of 25 l/min (instead of 20 l/min); and

a drum rotation speed of 5 rpm (instead of 30 rpm).

The sand obtained in Example 5 had a dustiness of 1.4 g/kg sand and the sand obtained in Comparative Example 2 12.5 g/kg sand.

### Discussion

As can be seen from Table 1, the sands as obtained in Examples 1-4 according to the present invention showed a significantly higher asphaltene content when compared to Comparative Example 1.

Furthermore, the sands as obtained in Examples 1-4 according to the present invention showed a reduced dustiness when compared with Comparative Example 1.

Also, using the (slightly adapted) DIN-5992-1 method, the sands as obtained in Example 5 according to the present invention showed a reduced dustiness when compared with the sand as obtained in Comparative Example 2.

1. A method for extracting bitumen from an oil sand feed stream (10), the method comprising at least the steps of:
(a) providing an oil sand feed stream;
(b) contacting the oil sand feed stream with a liquid comprising an aliphatic hydrocarbon solvent thereby obtaining a solvent-diluted oil sand slurry;
(c) separating the solvent-diluted oil sand slurry, thereby obtaining a solids-depleted stream and a solids-enriched stream; and
(d) removing solvent from the solids-enriched stream thereby obtaining a dry product comprising sand and bitumen, wherein the bitumen in the dry product comprises at least 40 wt. % asphaltenes.

2. The method according to claim 1, wherein the bitumen in the dry product comprises at most 95 wt. % asphaltenes.

3. The method according to claim 1 or 2, wherein the solvent in step (b) comprises an aliphatic hydrocarbon having from 3 to 9 carbon atoms per molecule.

4. The method according to any one of claims 1-3, wherein the solvent-diluted oil sand slurry has a solvent-to-bitumen (S/B) weight ratio of above 1.0.

5. The method according to claim 1 wherein the solvent is removed from the solids-enriched stream such that the dry product contains less than 500 ppmw of the solvent.

6. The method according to claim 1 wherein during the removal of the solvent, the water content of the dry product is not increased.

7. A product obtainable by the method according to claim 1.

8. A composition at least comprising sand and bitumen, wherein the bitumen contains at least 40 wt. % asphaltenes.

9. The composition according to claim 8, wherein the bitumen contains at least 50 wt. % asphaltenes.

10. The composition according to claim 8 wherein the bitumen comprises at most 95 wt. % asphaltenes.

11. The composition according to claim 8 comprising from 80 to 98 wt. % sand.

12. The composition according to claim 8 comprising from 0.1 to 10.0 wt. % bitumen.

13. The composition according to claim 8 wherein at least 90 wt. %.

14. The composition according to claim 8 wherein the composition comprises less than 500 ppmw.

15. The composition according to claim 8 wherein the composition has a dustiness of less than 10 g/kg sand as determined by DIN-5992-1.

16. Use of the product according to claim 7 in sulphur concrete, sulphur and bitumen based concrete or asphalt.
